(19) United States
(12) Patent Application Publication
(10) Pub. No.: US 2008/0023581 A1
(43) Pub. Date: Jan. 31, 2008

(54) TAPE DISPENSER

(76) Inventor: Bonni Shevin Sandy, Morton Grove, IL (US)

Correspondence Address: PERKINS COIE LLP, POST OFFICE BOX 1208, SEATTLE, WA, 98111-1208, US

(21) Appl. No.: 11/774,353

(22) Filed: Jul. 6, 2007

(51) Int. Cl. B65H 75/02; B26B 11/00; G06F 15/02; B27F 7/17

(52) U.S. Cl. 242/600; 227/19; 7/160; 708/105

(57) ABSTRACT

A desk or office accessory, such as an adhesive tape dispenser, has a base holding one, two, or more smaller office sub-components or devices that may be removed from the base, used as preferred, and then optionally returned or reattached to the base. The sub-components may be, for example, a calculator, a staple remover, a letter opener, etc. The sub-components may be attached to the base via magnets, Velcro hook and loop tape, fasteners, adhesive areas, etc. The base may include areas intended be printed with or holding an image, such as a photograph, artwork, corporate logo, etc.

### BACKGROUND OF THE INVENTION

The field of the invention is desk and office products and accessories. A multipurpose device is disclosed useful for conveniently holding or storing multiple useful desk or office objects or tools. Potential for desk clutter and misplacing objects is reduced.

### SUMMARY OF THE INVENTION

In one design, a base or primary structure is provided in the form of a tape dispenser. The base may also act as a paper weight. The base may include one, two, or more smaller office sub-components or devices that may be removed from the base, used as preferred, and then optionally returned or reattached to the base. The sub-components may be, for example, a calculator, a staple remover, a letter opener, etc. The sub-components may be attached to the base via magnets, Velcro hook and loop tape, fasteners, adhesive areas, etc. The base may include areas intended be printed with or holding an image, such as a photograph, artwork, corporate logo, etc.

Other objects, features and advantages will be apparent from the following detailed description, which shows alternative embodiments. The drawings are provided to show examples and should not be understood as limitations on the scope of the invention. The invention resides as well in sub combinations of the elements described and shown.

### BRIEF DESCRIPTION OF THE DRAWINGS

In the drawings, the same reference number indicates the same element in each of the views.

FIG. 1 is a perspective view of a base in the form of a tape dispenser with an attachable/detachable device in the form of a calculator.

FIG. 2 is a side view of the tape dispenser shown in FIG. 1.

FIG. 3 is a side view of the tape dispenser as in FIG. 2 where the calculator of other sub-component is detached from the tape dispenser.

FIG. 4 is a front view of the tape dispenser shown in FIG. 1.

FIG. 5 is a rear view of the tape dispenser shown in FIG. 1.

FIG. 6 is a top view of the tape dispenser shown in FIG. 1.

### DETAILED DESCRIPTION OF THE DRAWINGS

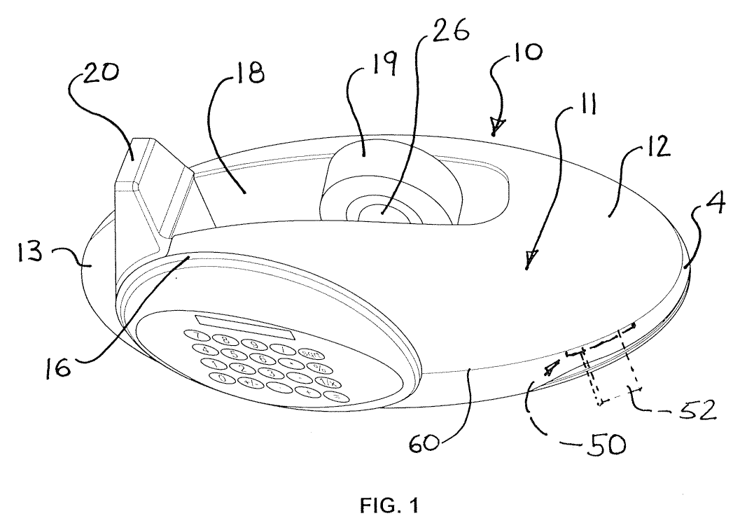

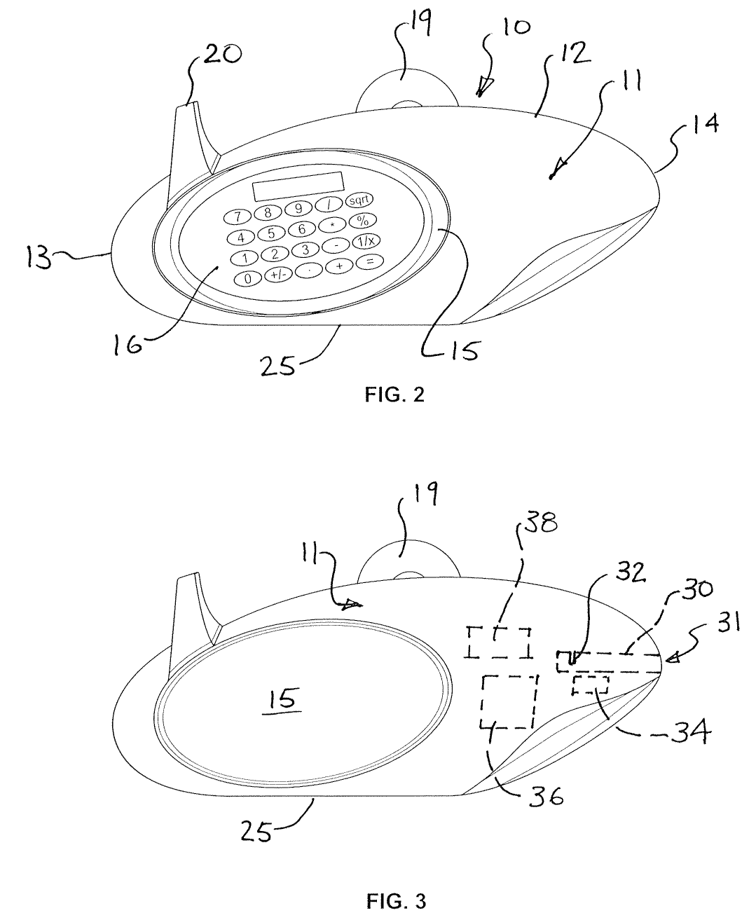

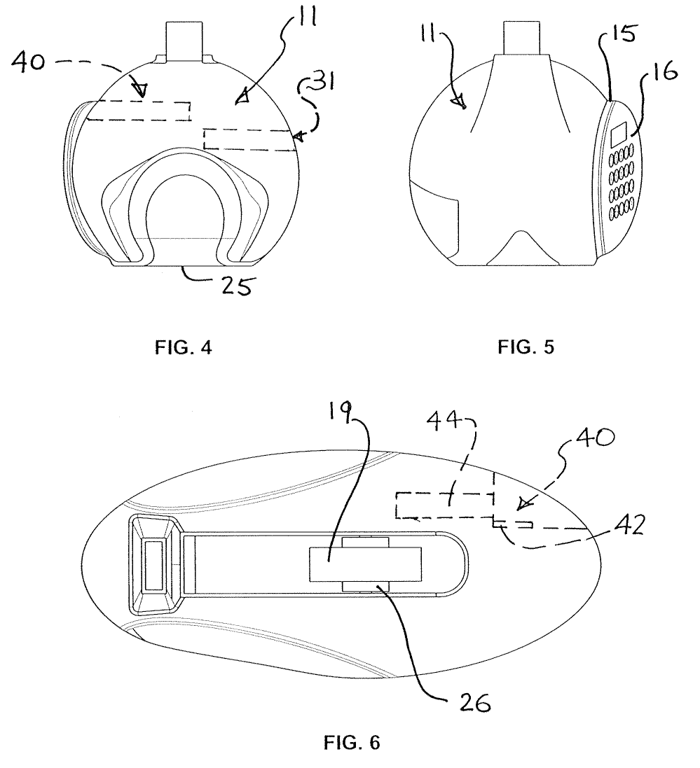

Turning now to FIGS. 1-6, an office accessory base is provided, in this example, in the form of a tape dispenser 10 having a generally ellipsoidal or ovoid body 11. The body 11 has a top surface 12, a front end 13, and a back end 14, which are typically smoothly curved. The body 11 also preferably at least one flat side panel 15 and a flat bottom surface 25. The flat side panel 15, in the design shown, has at least one attachment element, for example a magnet or other fastener attached or embedded in it, for holding a desk device 16. The desk device 16 has a corresponding or counterpart attachment element, to allow the device 16 to be attached onto and removed from the body 11.

As shown in FIG. 3, the office tool 16 has been removed, exposing the side panel 15. In one embodiment, the fasteners 21 may be attached to the exposed portion of the side panel. In another embodiment, the fasteners may be embedded within the panel.

As shown in FIG. 6, the tape dispenser 10 may have flat panel 15 on both sides of the body, for two detachable devices. Examples of other devices are rulers, conversion tables, calendars, note pads, and business card holders.

As shown in FIGS. 1, 2 and 5, in one embodiment, the desk device 16 is a calculator that is stored on the side panel 15 of the tape dispenser while not in use, but may be detached and used on its own. Other devices may also be used, including non-flat devices, and they may be similarly attached for holding, and detached for use, from the body 11.

In the design shown, a slot 18 in the top surface 12 is provided suitable for holding a roll of adhesive tape 19 on a spool 26. Al projection 20 extends up from the front end 14 of the top surface 12, with a cutting edge provided for cutting the tape 19.1

As shown in FIG. 3, a slot 30 at the back end 14 of the body 11 may be provided with a cutting edge 32 to provide a letter opener 31 for slicing open envelopes. Alternatively, an electrically powered letter opener may be provided. In this design, a motor 36 drives rollers 34 to draw the envelope across the cutting edge 32. The motor 36 may be powered by batteries 38 contained within the body. Alternatively, a power cord may extend from the motor 36 out of the body 11 and to a wall socket.

Referring to FIG. 6, in place of, or in addition to, the letter opener 31, a stapler 40 may be provided in or on the body 11. The stapler 40, if included, typically has a slot opening in the body 11, like the letter opener 31. A switch 42 in the slot activates a stapling mechanism 44 when contacted by papers inserted into the slot. As shown in FIG. 1, the body 11 may be formed by separate top and bottom shells or halves, separated by a parting line 60. This allows the body 11 to be opened up to load staples into the stapler 40. Also as shown in FIG. 1, a flag or posit dispenser may be provided on the body 11.

Thus, novel desk accessories have been shown and described. Various substitutions and changes may of course be made without departing from the spirit and scope of the invention. The invention, therefore, should not be restricted, except by the following claims, and their equivalents.

1. A desk accessory, comprising;
a base having at least one generally flat side;
a tape roll spool on the base;
an office device having a generally flat surface releasably attachable to the generally flat side of the base.

2. The desk accessory of claim 1 further including a letter opener within the base.

3. The desk accessory of claim 1 further including a stapler within the base.

4. The desk accessory of claim 1 wherein the office device comprises a calculator.

5. The desk accessory of claim 1 wherein the office device comprises a printed card.

6. The desk accessory of claim 1 wherein the office device is releasably attachable to the base via magnets.

7. The desk accessory of claim 1 wherein the office device is releasably attachable to the base via hook and loop tape.

8. The desk accessory of claim 1 wherein the office device is releasably attachable to the base via one or more mechanical fasteners.

9. The desk accessory of claim 4 wherein the calculator and the generally flat side of the base have substantially the same shape.

10. A tape dispenser comprising;
an oblong base having curved upper and lower surfaces, a flat bottom surface and first and second generally flat side areas;
a tape roll spool in a slot in the base;
a tape cutter adjacent to a front end of the base;
a calculator having a generally flat back surface releasably attachable to the first or second generally flat sides.

11. The tape dispenser of claim 10 further comprising a generally horizontal letter opener slot at a back end of the base, opposite from the front end; and further comprising a cutting blade in the letter opener slot, adapted for opening letters.

12. The tape dispenser of claim 10 further comprising a stapler in the base.

13. The tape dispenser of claim 12 further comprising one or more batteries within the base and linked to an electrical actuator for operating the stapler.

14. The tape dispenser of claim 10 further comprising a stationery flag dispenser in the base.

15. The tape dispenser of claim 10 with the back surface of the calculator having a size and shape generally matching the first generally flat side area of the base.

16. A tape dispenser, comprising;
an oblong base having curved upper and lower surfaces, a flat bottom surface and first and second generally flat side areas;
a tape roll spool in a slot in the base;
a tape cutter adjacent to a front end of the base;
a calculator having a generally flat back surface;
a first magnetic element in or on the back surface of the calculator;
a second magnetic element in or on at least one of the first and second generally flat side areas of the base; and
an electrically powered letter opener in the base.
